(19) United States
(12) Patent Application Publication
(10) Pub. No.: US 2016/0324119 A1
(43) Pub. Date: Nov. 10, 2016

(54) Protective Equine Leg Boot

(71) Applicant: Brett W. Mills, Redmond, OR (US)

(72) Inventor: Brett W. Mills, Redmond, OR (US)

(21) Appl. No.: 14/706,844

(22) Filed: May 7, 2015

(51) Int. Cl. A01K 13/00

(52) U.S. Cl. CPC A01K 13/007

(57) ABSTRACT

Equine boots with integrated, impact protection are disclosed. In one embodiment an equine leg boot includes a fabric body with an outer surface and an inner surface, the fabric body being configured to wrap around the lower leg of a horse. An impact-resistant protective member is disposed within the fabric body. A suspensory support strap is also provided, at least a portion of which is integral with the fabric body.

### BACKGROUND

Equine protective leg boots are well known in the art. They are used to support and protect the anatomy of the lower leg of the horse during exercise. One of the most delicate areas of the horse's anatomy is the area of the canon bone, fetlock joint and pasturn regions of the lower leg below the knee and hock joints including the flexor tendons and suspensory ligaments. They can be damaged in a number of ways including via striking by a hard object.

When under load, the suspensory ligament is particularly susceptible to traumatic damage by overstrike by the hoof of the hind leg due to its location on the posterior aspect of the front leg. Damage to this ligament can be often severe resulting in complete failure of the ligament and damage to surrounding tissues. A catastrophic injury to the suspensory ligament could effectively end the useful career of the horse requiring either expensive reconstructive surgery and rehabilitation or destruction of the animal.

### SUMMARY

Generally, this invention relates to equine leg boots, more specifically equine leg boots that provide impact protection to the posterior aspects of the front legs and support to the associated ligaments, tendons and tissues of the lower leg.

In one aspect, the invention features an equine leg boot comprising a fabric body configured to wrap around the lower leg of a horse, an impact-resistant protective member disposed within the fabric body, and a suspensory support strap, at least a portion of which is integral with the fabric body.

Some implementations include one or more of the following features. The protective member may comprise a formed thermoplastic sheet material. The fabric body may define a pocket in which the protective member is disposed. An outer surface of the fabric body may be formed of a hook-engageable material. In some cases, substantially the entire outer surface of the fabric body is formed of the hook-engageable material. In some implementations, the fabric body is formed of a neoprene laminate.

The support strap may be configured to provide support to the fetlock joint/suspensory ligament and surrounding tissues. In some cases, the protective member has a wall thickness of from about 0.05 to 0.1 inch. The protective member may be shaped to provide a space between the protective member and a surface of a posterior aspect of the horse's leg. For example, the protective member may include a bulbous portion shaped to conform to a fetlock joint of the lower leg.

### DESCRIPTION OF THE DRAWINGS

FIG. 1 is a front, left perspective view of the device shown installed.

FIG. 2 is a front, right perspective view of the device shown in FIG. 1.

FIG. 3 is a rear perspective view of the device shown in FIG. 1.

FIG. 4 is a perspective view of the protective member.

FIG. 5 is a perspective view of the device shown in the open position.

FIG. 6 is a cross-sectional view of device installed taken about indicator 6 as seen in FIG. 2.

### DETAILED DESCRIPTION

The present disclosure relates generally to a protection system for horses, more specifically protective leg boots that prevent damage to the bones, tendons, ligaments and other structures of the front leg of a horse that can result from external striking, such as striking by an over reaching hind foot.

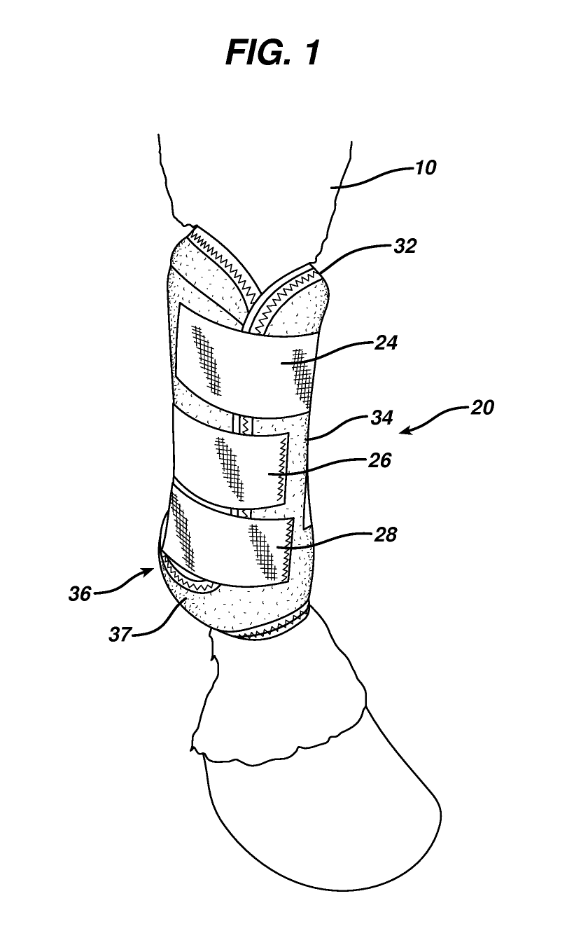

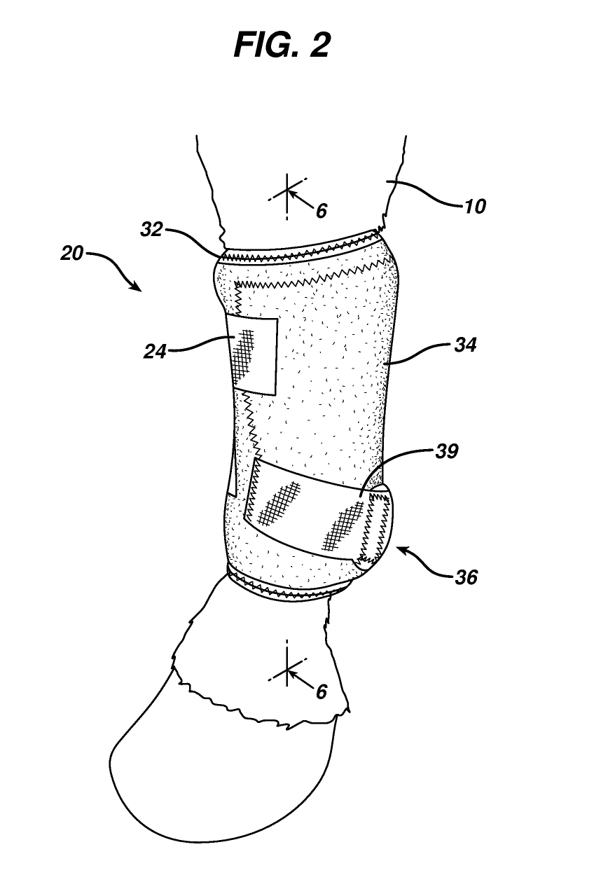

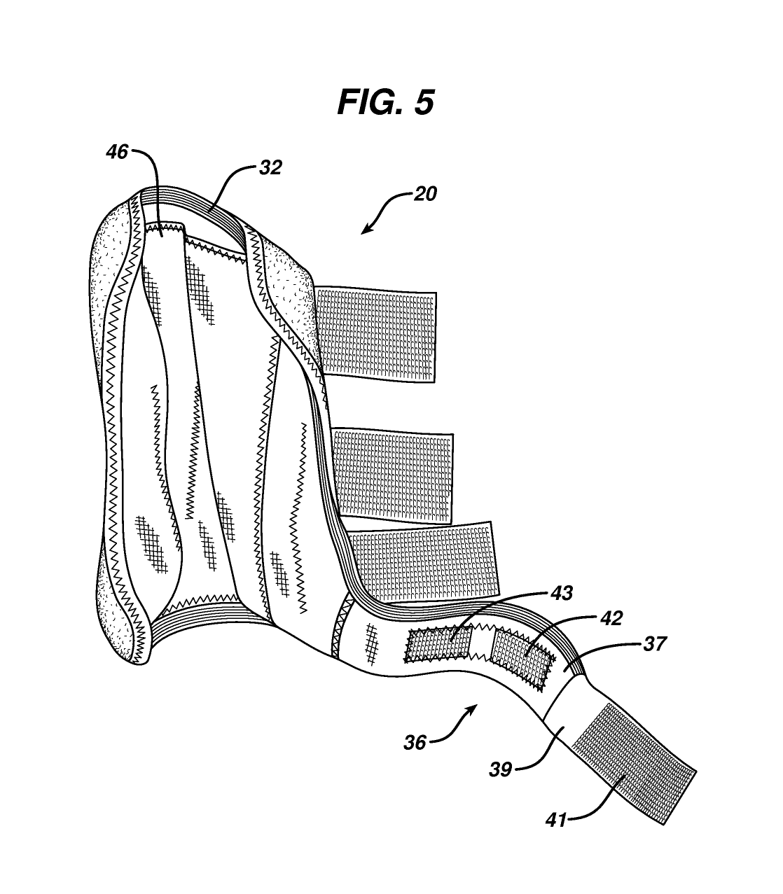

Referring to FIGS. 1-3, the boot 20 is dimensioned to substantially surround the lower portion of the front leg of a horse 10. The boot is configured with a plurality of attachment straps 24, 26, 28 and a suspensory support strap 36. Straps 24, 26 and 28 are fixedly attached on one end to the outer surface 34 of the boot 20 and have hook fasteners on their boot-facing surfaces. Referring to FIG. 5, the suspensory strap 36 is formed of an elongated member 37 on the lower, bulbous portion of the boot 35. Fastening portion 39 is fixedly attached, e.g. sewn, to the elongated member 37 and is configured with loop-style fasteners on the inner surface 41. The suspensory strap 36 is contiguous with the boot and is configured to substantially wrap under and around the fetlock joint of the leg. When secured, the suspensory strap provides additional support and stability to the fetlock joint and the surrounding tendons and ligaments, e.g. the suspensory ligament.

The outer surface 34 of the boot is constructed of a substantially smooth material that is complementary to a hook fastener, preferably a laminated neoprene material or similar. For example, the boot maybe constructed of neoprene fabric laminate having a hook-engageable, unbroken loop surface, such as those commercially available from Macro International. This configuration advantageously allows a great amount of strap adjustability and placement enabling the boot to accommodate a large variety of differently sized horse legs. This is due to the fact that there is no predetermined location or orientation in which the attachment straps must be placed to ensure proper fastening. Neoprene or a similar material is preferably used because it provides cushioning, flexibility and comfort over a wide variety of temperatures.

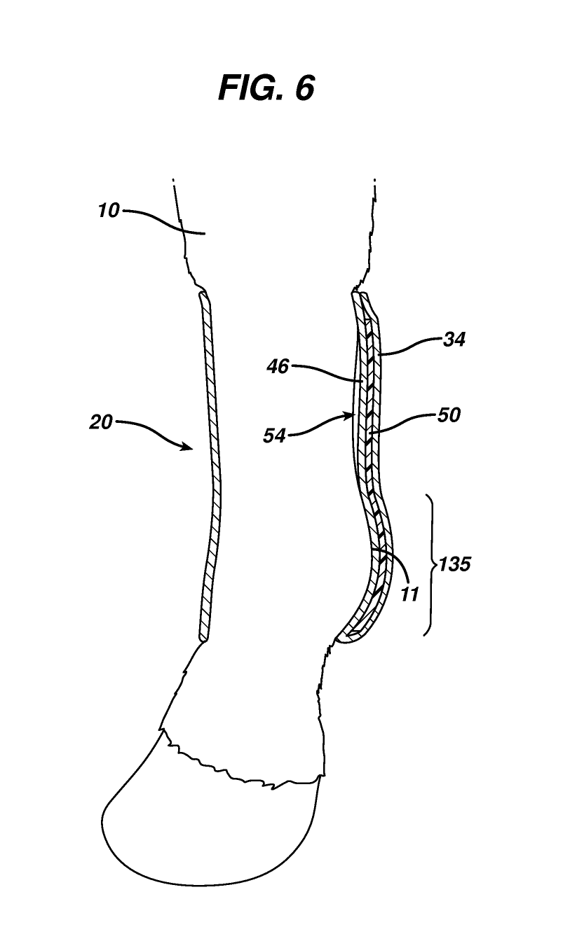

Referring to FIG. 6, the boot is configured with a protective member 50 positioned to protect the posterior aspect of the leg and the fetlock joint from impact, for example, from an accidental hind hoof strike. The protective member is preferably integrated into the structure of the boot such that the exterior of the boot is substantially completely covered by the hook-engageable material. As seen in FIG. 5, panel 46, located on the inner surface of the boot, defines a pocket in which the protective member is fitted. Providing the protective member in this pocket protects the protective member from damage or dislodgement during use.

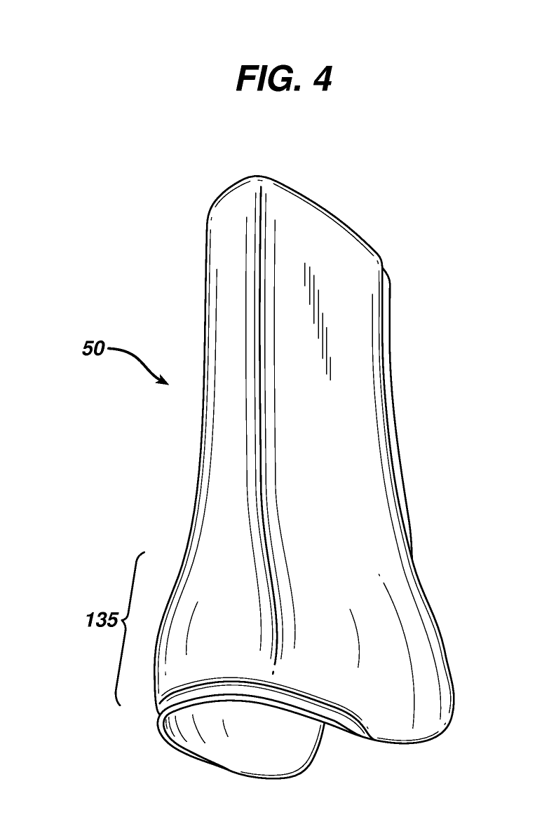

Referring to FIG. 4, protective member 50 is preferably constructed of a semi-rigid thermoplastic that has sufficient strength to deflect and dissipate or absorb an impact, such as when struck by a hind hoof. It is pre-formed to be compatible with the external anatomy of the lower leg of the horse and is flexible enough along its short/horizontal axis to accommodate variations in the leg anatomy. The protective member should generally be thick enough to provide good protection, while avoiding imparting unnecessary weight to the boot. In some implementations, the protective member may have a thickness of from about 0.05 to 0.1 inch. The protective member includes a bulbous area 135 that is shaped to cover the fetlock joint of the horse.

Referring to FIG. 5, panel 46 is attached to the inner surface of the boot, e.g., by stitching or the like. Panel 46 is preferably a neoprene fabric that provides padding and flexibility ensuring comfort while minimizing skin irritation, and may be the same fabric used to form the rest of the boot.

Sections 42, 43 include hook fastener material (e.g., of a hook and loop fastener system such as those sold under the tradename VELCRO®) attached to the inner surface of suspensory strap 36, which are positioned to engage with the outer surface of the boot when the suspensory strap is closed. As previously mentioned, the outer surface 34 of the boot is includes a hook engageable material, e.g., a material carrying loop fasteners or otherwise having a surface that engages with the corresponding hook fasteners on the straps ensuring a secure, releasable connection. The additional connections provided by sections 42, 43 improve the closure strength of the suspensory strap during use, for example, when the horse is flexing and extending the fetlock jock as would occur during movement.

Referring to FIGS. 1 and 5, trim 32 defines the edge of the horse boot and is preferably one contiguous piece of stretchy material. Furthermore, when the boot is applied to horse's leg, the trim helps create a barrier that prevents dirt and other contaminants from getting between the boot and the horse's leg while in use.

Referring to FIG. 6, when the boot 20 is properly fitted on the leg 10, the protective member 50 does not sit flush with the posterior aspect of the leg 11 above the fetlock joint. Rather, there is a pocket of free space 54 created by the shape of protective member 50 that helps aid in deflecting and/or absorbing impact strikes thereby eliminating catastrophic damage to the suspensory ligament and surrounding tissues. The bulbous area 135 of the protective member 50 is configured to conform to the external anatomy of the fetlock joint, thereby providing improved structure to the boot and protection to the fetlock joint.

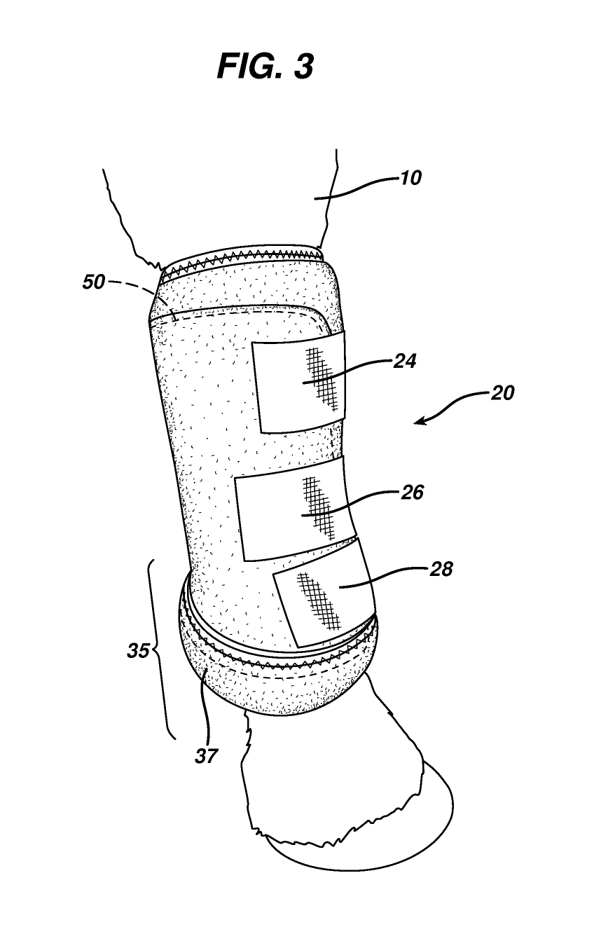

To apply the boot to a front leg of a horse, the user first unfastens the straps and opens the boot. The user would then position the boot on the leg such that the fetlock joint is substantially covered by the bulbous area 35 of the boot, as seen in FIG. 3. Straps 24, 26, 28 are then sequentially tensioned and secured to outer surface 34. Suspensory strap 36 is then tensioned and wrapped around and under the fetlock joint and secured to outer surface 34. When properly fitted, the boot is designed to fit in such a manner that it does not move or become dislodged during use. To remove the boot, the user would reverse these steps.

### Other Embodiments

A number of embodiments have been described. Nevertheless, it will be understood that various modifications may be made without departing from the spirit and scope of the disclosure.

For example, the boot may be configured with replaceable retention devices. For example, in some implementations strap 24 is not sewn to the boot and thus can be replaced when worn or interchanged for branding (e.g. with a particular logo). If desired, one or more of the other attachment straps can also be removable.

Accordingly, other embodiments are within the scope of the following claims.

1. An equine leg boot comprising:
a fabric body configured to wrap around the lower leg of a horse,
an impact-resistant protective member disposed within the fabric body, the protective member comprising a semi-rigid thermoplastic material that is pre-formed to have a molded shape that conforms to the back of the lower leg of the horse and thereby wraps around the posterior aspect of the lower leg and provides impact protection to the flexor tendons of the horse, and
a suspensory support strap, at least a portion of which is integral with the fabric body.

2. (canceled)

3. The device of claim 1 wherein the fabric body defines a pocket and the protective member is disposed within the pocket.

4. The device of claim 1 wherein an outer surface of the fabric body is formed of a hook-engageable material.

5. The device of claim 1 wherein the support strap is configured to provide support to the fetlock joint/suspensory ligament and surrounding tissues.

6. The device of claim 1 wherein the protective member has a wall thickness of from about 0.05 to 0.1 inch.

7. The device of claim 1 wherein the protective member is shaped to provide a space between the protective member and a surface of a posterior aspect of the horse's leg.

8. The device of claim 1 wherein the fabric body is a neoprene fabric laminate.

9. The device of claim 1 wherein the protective member includes a bulbous portion shaped to conform to a fetlock joint of the lower leg.

10. The device of claim 1 wherein the attachment straps include hook fasteners.

11. The device of claim 1 wherein the suspensory support strap has a portion with hook fasteners.
